(19) United States
(12) Patent Application Publication
(10) Pub. No.: US 2016/0348046 A1
(43) Pub. Date: Dec. 1, 2016

(54) BREWING APPARATUS AND METHOD OF USE

(71) Applicant: WILLIAMSWARN HOLDINGS LIMITED., Hastings (NZ)

(72) Inventor: Samuel Wilfred WOOD, Hastings (NZ)

(21) Appl. No.: 15/111,963

(22) PCT Filed: Jan. 28, 2015
(86) PCT No.: PCT/NZ2015/050003

§ 371 Date: Jul. 15, 2016

(30) Foreign Application Priority Data
Jan. 29, 2014 (NZ) 620490
May 8, 2014 (NZ) 624739

(51) Int. Cl. C12C 13/10; C12C 13/02; C12H 1/22

(52) U.S. Cl. CPC C12C 13/10; C12H 1/22; C12C 13/02

(57) ABSTRACT

A brewing apparatus for small scale brewing of fermented beverages such as beer and cider and a method of brewing using the apparatus is described. The brewing apparatus includes a single pressurizable vessel in which all the steps of the brewing process can be carried out, including fermentation, carbonation (naturally during fermentation), sediment removal, maturation and draw off. The brewing apparatus includes a safety pressure release system to relieve pressure from within the brewing vessel if the pressure differential between the interior and the exterior of the brewing vessel exceeds a predetermined pressure. The brewing apparatus is configured so it can be easily transported from one location to another. In one embodiment, the brewing apparatus has a scalable lid or hatch which includes all of the necessary components and connections located therein.

### FIELD OF THE INVENTION

This invention relates to a brewing apparatus and a method of brewing using the apparatus, particularly but not exclusively for small scale brewing of alcoholic beverages such as beers and ciders.

### BACKGROUND

The applicant has been involved in the development and manufacture of brewing apparatus for some years. They have primarily been involved in the development of “all-in-one” brewing systems that enable home brewers to produce high quality and specialty beverages, mainly beers and ciders.

These systems typically comprise a multi-role single vessel which is able to carry out the entire brewing process, including fermentation, carbonation, maturation, sediment removal, storage and dispense. Such systems are described in PCT Patent Application No. PCT/NZ2008/000191. The systems described in this document include ‘on-board’ temperature management equipment that is used to achieve the accurate temperature control necessary in brewing processes.

The applicant's systems have considerable advantages over previous home brewing systems and techniques, and over large scale brewing operations, the advantages including:
Precise control of fermentation and maturation temperatures can be achieved, irrespective of the surrounding ambient temperature;
The self contained brewing vessels can also be used in the maturation step, and to store the beverage, and the beverage can be dispensed directly from the vessel;
Sediment can be removed directly from the brewing vessel without risk of contaminating the beverage;
The elimination of the need for any post fermentation handling which;
   saves time,
   eliminates the need for bottling,
   allows the fermentation CO2 to be retained, eliminating the need for post fermentation re-carbonation and the associated dwell time,
   eliminates the possibility that the beverage can be contaminated from low levels of impurities in any introduced CO2, and
   almost completely eliminates the possibility of post fermentation O₂ contamination, or bacterial contamination.

The combination of these advantages allows a fresher beverage to be produced, and a beverage having a longer shelf life.

The ability of such systems to not only produce fine beverages, but also to keep them free from contaminants and to store them well, allows high quality and fresh beverages to be consistently produced. For these reasons, such systems are becoming very popular for the home brewer and increasingly for bars and restaurants that brew their own beverages such as craft beers and ciders.

However, there are some disadvantages with such systems. As they are relatively complex, they are costly to produce. The many components and fittings included in and around the vessel make it costly to manufacture and therefore expensive for consumers. The systems also require some regular maintenance due to all the different components and fittings. This is particularly the case in respect of the ‘on-board’ temperature control equipment that is integral with the vessel. The systems can also be difficult to clean thoroughly. Thorough cleaning can be time consuming due to the many components attached and penetrating into the vessel which can be hard to access.

In addition, there are safety concerns in relation to pressurized brewing vessels. It is always a possibility that a pressurised fermentation vessel may become over-pressurised and fail, which can have catastrophic results. Pressure relief valves are typically used in brewing practices to avoid such catastrophes. However, such valves can be susceptible to sticking and failing and the narrow orifices and lines leading to such valves can also become clogged, preventing the proper safe operation of the valves. The fermentation process can produce tacky residues which are able to clog the narrow orifices or lines to the pressure relief valves.

In this specification unless the contrary is expressly stated, where a document, act or item of knowledge is referred to or discussed, this reference or discussion is not an admission that the document, act or item of knowledge or any combination thereof was at the priority date, publicly available, known to the public, part of common general knowledge; or known to be relevant to an attempt to solve any problem with which this specification is concerned.

### OBJECT

It is therefore an object of the present invention to provide an improved brewing apparatus and a method of use which will at least go some way towards overcoming one or more of the above mentioned disadvantages, or at least provide the public with a useful choice.

### STATEMENTS OF THE INVENTION

Accordingly, in a first aspect, the invention may broadly be said to consist in a brewing apparatus, the apparatus having;
a brewing vessel configured to contain material to be fermented and to hold the material at a pressure above atmospheric pressure as the material ferments,
the vessel having a sealable lid or hatch, and
the vessel having a resilient seal configured to make a fluid tight seal between the vessel and the lid or hatch;

wherein the apparatus is configured such that the seal is situated within a sealing groove, and at least a part of the seal is able to exit the sealing groove and to relieve pressure from within the brewing vessel if the pressure differential between the interior and the exterior of the brewing vessel exceeds a predetermined pressure.

Preferably the resilient seal is an O-ring.

Preferably the O-ring is normally contained within an O-ring groove, and a gap is provided outboard of the O-ring groove, the gap being configured to allow at least a part of the O-ring to exit the O-ring groove if the pressure differential between the interior and the exterior of the brewing vessel exceeds the predetermined pressure.

Optionally the gap between the brewing vessel and the sealable lid or hatch extends around the entire circumference of the O-ring.

Preferably the predetermined pressure is between 2.5 and 3.0 bar.

Preferably the apparatus also includes dosing means configured to allow materials such as clarifying agents to be introduced into the vessel while the vessel is pressurised.

Preferably the apparatus also includes sedimentation removal means configured to allow sedimentation products to be removed from the vessel while the vessel is pressurised.

Preferably the apparatus also includes a pressure regulating valve configured to relieve pressure from within the vessel before the pressure differential between the interior and the exterior of the brewing vessel exceeds the predetermined pressure which causes the seal to exit the sealing groove.

Preferably the apparatus also includes a dispensing system configured to allow liquid within the vessel to be dispensed while the vessel is pressurised.

Preferably the apparatus also includes a pressurization system configured to allow gas under pressure to be introduced into the vessel.

Preferably the apparatus also includes a heating system configured to allow material inside the vessel to be heated to, or maintained at a desired temperature above ambient temperature.

Preferably the apparatus also includes a cooling system configured to allow material inside the vessel to be cooled to, or maintained at a desired temperature below ambient temperature.

In a second aspect, the invention may broadly be said to consist in a brewing apparatus, the apparatus having;
a brewing vessel configured to contain material to be fermented and to hold the material at a pressure above atmospheric pressure as the material ferments,
the vessel having a sealable lid or hatch,
a pressure regulating valve configured to relieve pressure from within the vessel if the pressure differential between the interior and the exterior of the brewing vessel exceeds a predetermined pressure, and
a dispensing system configured to allow liquid within the vessel to be dispensed while the vessel is pressurised;

wherein the apparatus is configured for transportation from one location to another.

Preferably the apparatus includes a removable carriage assembly.

Preferably the apparatus is configured to allow it to be stacked on top of similarly configured brewing apparatus.

Preferably the apparatus includes wheels configured to allow it to be moved with ease from one location to another.

Preferably the apparatus also includes dosing means configured to allow materials such as clarifying agents to be introduced into the vessel while the vessel is pressurised.

Preferably the apparatus also includes sedimentation removal means configured to allow sedimentation products to be removed from the vessel while the vessel is pressurised.

Preferably the removable carriage assembly is configured to provide space between the lowest part of the vessel and the ground sufficient for installation and removal of a sediment collection vessel to and from the brewing vessel.

Preferably the apparatus also includes a pressurization system configured to allow gas under pressure to be introduced into the vessel.

Optionally the apparatus also includes a heating system configured to allow material inside the vessel to be heated to, or maintained at a desired temperature above ambient temperature.

Optionally the apparatus also includes a cooling system configured to allow material inside the vessel to be cooled to, or maintained at a desired temperature below ambient temperature.

In a third aspect, the invention may broadly be said to consist in a brewing apparatus, the apparatus having;
a brewing vessel configured to contain material to be fermented and to hold the material at a pressure above atmospheric pressure as the material ferments,
the vessel having a sealable lid or hatch,
the sealable lid or hatch having at least the following components situated therein:
(1) a pressure regulating valve configured to relieve pressure from within the vessel if the pressure differential between the interior and the exterior of the brewing vessel exceeds a predetermined pressure,
(2) a first coupling means configured to allow a compressed gas to be introduced into the vessel, and
(3) a second coupling means configured to receive a dispensing system to allow liquid within the vessel to be dispensed while the vessel is pressurised.

Preferably the first or second coupling means is also configured to receive a dosing system to allow materials such as clarifying agents to be introduced into the vessel while the vessel is pressurised.

Alternatively the sealable lid or hatch has a third coupling means for receiving a dosing system to allow materials such as clarifying agents to be introduced into the vessel while the vessel is pressurised.

Preferably the sealable lid or hatch also includes a pressure gauge or a means to receive a removable pressure gauge.

Preferably the sealable lid or hatch also includes one or more viewing windows to provide a view of the interior of the vessel.

Preferably the apparatus is configured for transportation from one location to another. For example, the vessel may comprise one or more wheels to enable it to be easily transported. More preferably, the apparatus includes a removable carriage assembly with wheels.

Preferably the apparatus has a resilient seal configured to make a fluid tight seal between the vessel and the lid or hatch, the seal being adapted to relieve pressure from within the vessel if the pressure differential between the interior and the exterior of the vessel exceeds a predetermined pressure.

More preferably the seal is situated within a sealing groove, wherein at least a part of the seal is able to exit the sealing groove to relieve pressure from within the vessel if the pressure differential between the interior and the exterior of the vessel exceeds a predetermined pressure.

Preferably the pressure regulating valve is configured to relieve pressure from within the vessel before the pressure differential between the interior and the exterior of the brewing vessel exceeds the predetermined pressure which causes the seal to exit the sealing groove.

Preferably the pressure regulating valve also includes a vacuum safety relief means.

Preferably the apparatus further includes sedimentation removal means configured to allow sedimentation products to be removed from the vessel while the vessel is pressurised.

Preferably the removable carriage assembly is configured to provide space and access sufficient for installation and removal of a sediment collection container to and from the brewing vessel.

Preferably the sediment collection container includes a drain valve to enable the accumulated sediment to be periodically drained as the sediment accumulates.

Preferably the apparatus is configured to allow it to be stacked on top of similarly configured brewing apparatus.

In a further aspect, the invention may broadly be said to consist in a brewing facility incorporating at least one brewing apparatus substantially as specified herein.

Preferably the brewing facility includes a public bar or restaurant at which the brewing apparatus can be used to dispense fermented beverages.

Preferably the brewing facility includes at least one temperature controlled chamber or room.

In a further aspect, the invention may broadly be said to consist in a method of home or small scale brewing of a fermented alcoholic beverage, wherein said method occurs in a brewing vessel as described herein, and wherein said method includes the steps of
a) adding the appropriate brewing ingredients to the vessel;
b) sealing the vessel;
c) selecting the desired pressure setting to allow carbonation of the contents of the vessel to occur naturally as a result of fermentation;
d) placing the brewing vessel into a first temperature controlled chamber or room while fermentation takes place;
e) allowing fermentation and natural carbonation to occur within the sealed vessel;
f) removing sediment from within the vessel while the vessel is under pressure;
g) moving the vessel to a second temperature controlled chamber or room prior to and during consumption of the beverage contained within the vessel.

Optionally the method includes movement of the vessel to a third temperature controlled chamber or room while maturation takes place.

The invention may also broadly be said to consist in the parts, elements and features referred to or indicated in the specification of the application, individually or collectively, and any or all combinations of any two or more of the parts, elements or features, and where specific integers are mentioned herein which have known equivalents, such equivalents are incorporated herein as if they were individually set forth.

### DESCRIPTION

Further aspects of the invention will become apparent from the following description which is given by way of example only and with reference to the accompanying drawings in which:

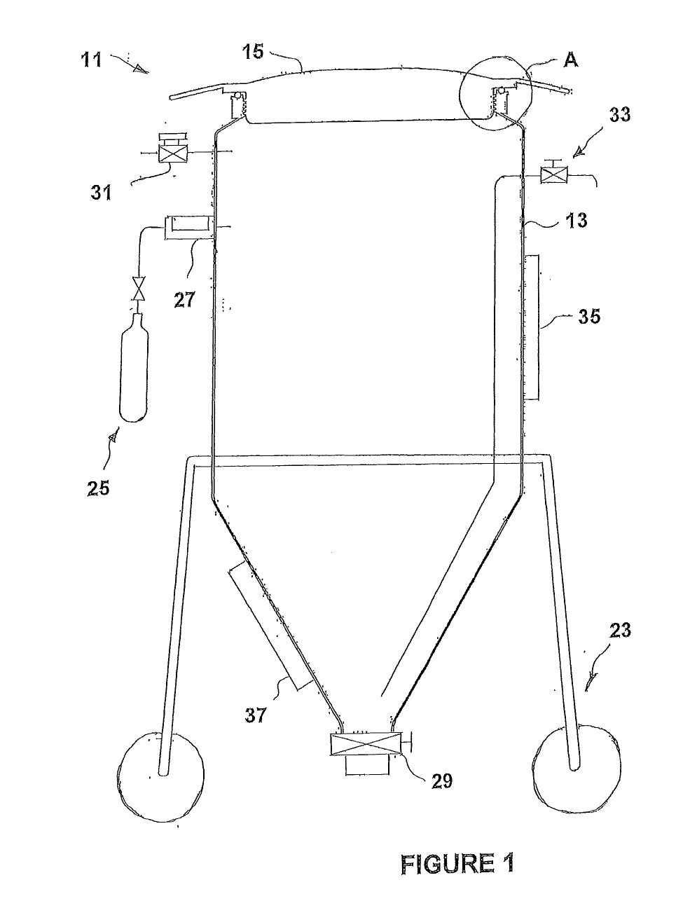

FIG. 1 is a side elevation schematic view of a first example of a brewing apparatus according to the invention,

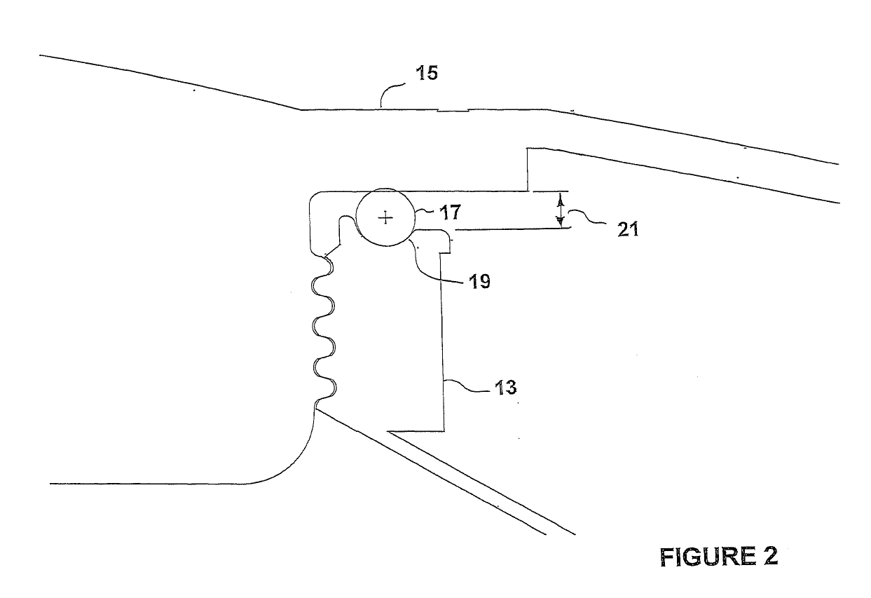

FIG. 2 is an expanded cross sectional detail A (as defined in FIG. 1) showing a seal configuration of the brewing apparatus,

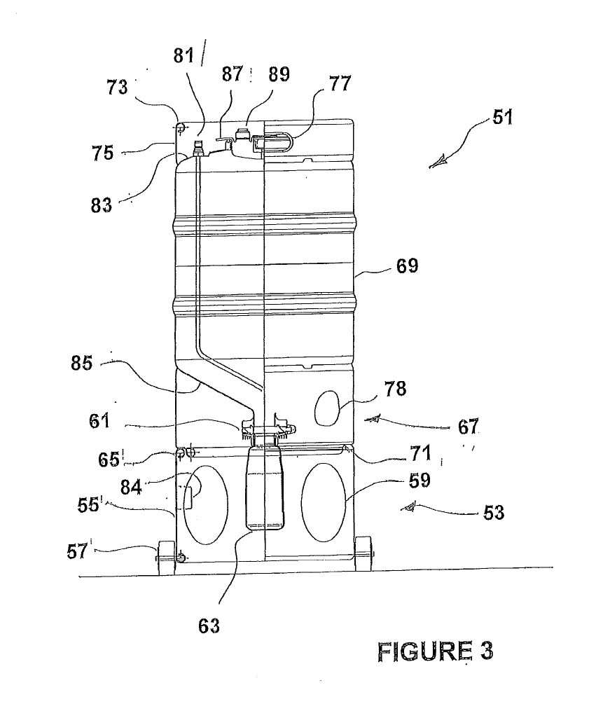

FIG. 3 is a partially cutaway side elevation of a second example of a brewing apparatus according to the invention,

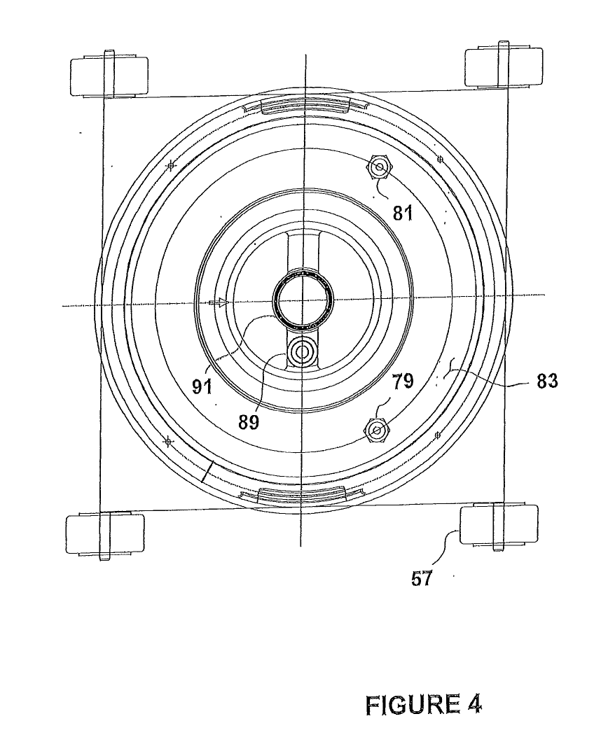

FIG. 4 is a plan view of the second example of a brewing apparatus,

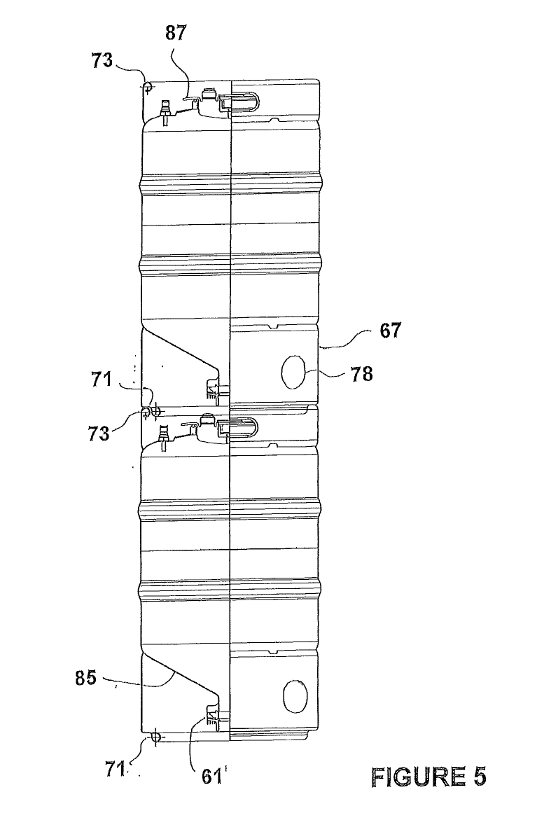

FIG. 5 is a side elevation showing the stackability of the keg portion (without the carriage assembly) of the second example of a brewing apparatus,

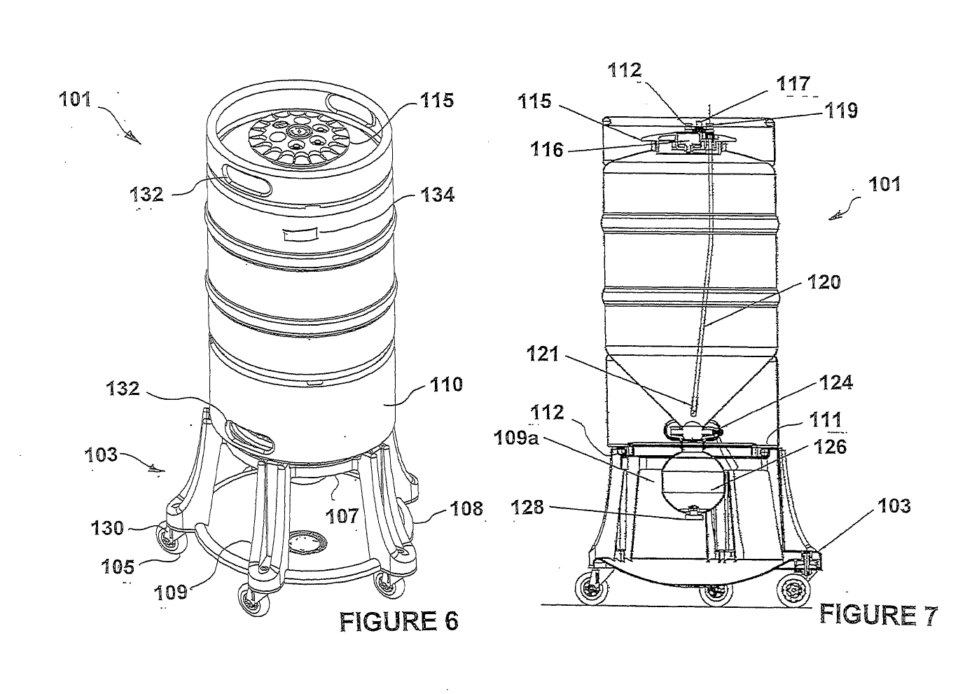

FIG. 6 is a perspective view of a third example of a brewing apparatus according to the invention,

FIG. 7 is a cross sectional view of the brewing apparatus of FIG. 6,

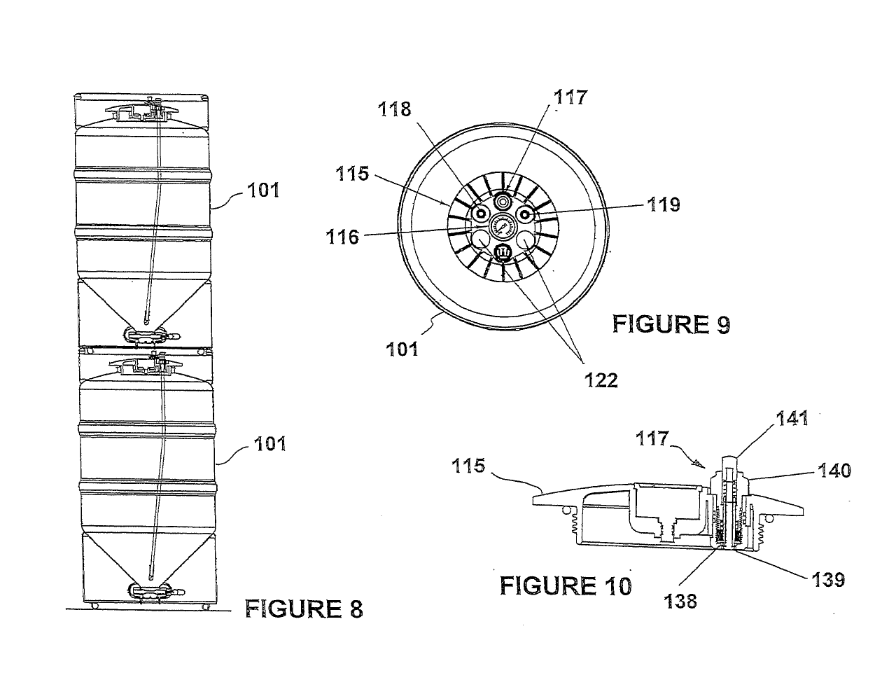

FIG. 8 is a side elevation showing the stackability of the keg portion (without the trolley or dolly assembly) of the third example of a brewing apparatus,

FIG. 9 is a top view of one of the keg portions of the brewing apparatus of FIG. 8,

FIG. 10 is a cross sectional view of the lid of a brewing apparatus according to the third example of the invention,

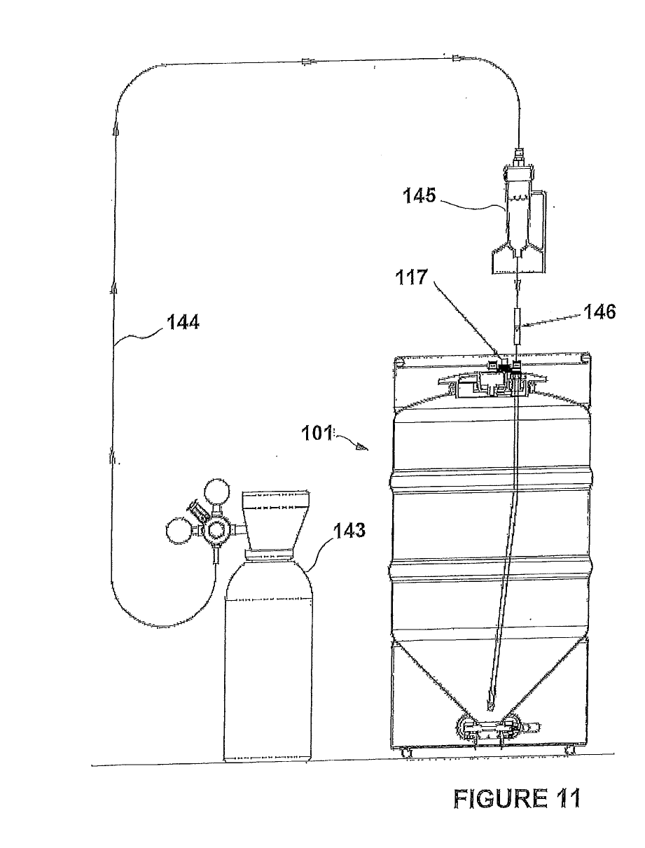

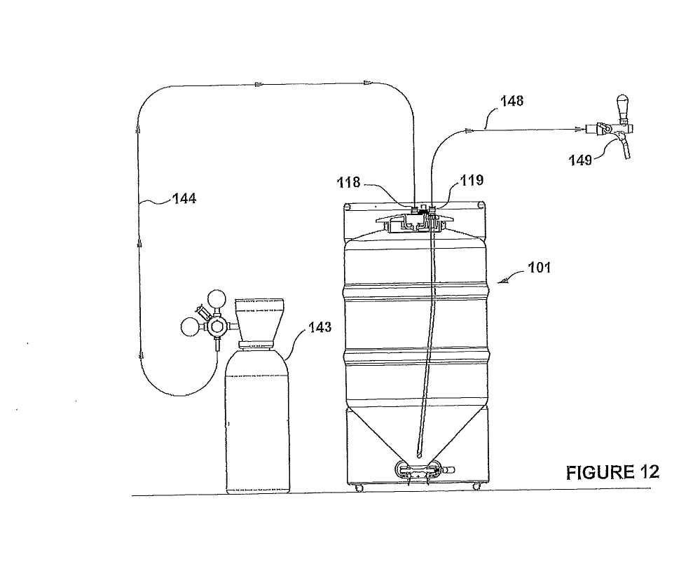

FIG. 11 is a schematic drawing showing a typical dosing configuration, and

FIG. 12 is a schematic drawing showing a typical dispensing configuration.

With reference to the drawings, several examples of a brewing apparatus according to the invention will now be described. The brewing apparatus is designed for producing fermented beverages in a batch process, in small or medium volumes typically in the range of five litres to one thousand (1000) litres. The brewing apparatus may be produced in both smaller and larger versions, where the larger variants may typically be used for production of craft beverages in bars and restaurants, and the smaller variants may be used for example in households or by hobbyists. It is envisaged that the brewing vessel of at least the smaller variants could be made of a suitable food grade plastics material that is light and easy to transport. Larger vessels could be made of a more heavy duty food grade plastics material or stainless steel or other suitable materials.

The brewing apparatus is an “all in one” system for brewing wherein the apparatus comprises a single pressurizable vessel which in use performs at least the brewing steps of fermentation, natural carbonation, sediment removal, maturation and draw off.

### FIRST EXAMPLE

With reference to FIGS. 1 and 2, a first example of a brewing apparatus (11) according to the present invention will now be described. The brewing apparatus (11) includes a brewing vessel (13) in which the fermentation occurs. The fermented beverage, including all or some of the carbon dioxide produced during the process, remains in the brewing vessel (13) while the beverage then goes through optional maturation and clarification processes and while the beverage is subsequently stored and also while it is being dispensed for consumption at home or at a licensed premises, thereby making it an “all-in-one” system for brewing.

The brewing vessel (13) is constructed in such a manner that it is able to hold the fermenting contents at a pressure above atmospheric pressure as the material ferments. The vessel has a sealable lid (15). The sealable lid may be made of a transparent food grade plastics material, preferably shaded or tinted to prevent light from penetrating the contents of the vessel. The apparatus (11) includes a pressure regulating valve (31) configured to relieve pressure from within the vessel at a desired pressure for the fermentation process. The brewing vessel (13) further comprises a safety pressure release system which acts as a back up to the pressure regulating valve (31). The safety pressure release system is located near the lid (15) of the vessel. As shown in FIG. 2, a resilient seal (17) provides a fluid tight seal between the vessel (13) and the lid (15). In this example, the resilient seal (17) is in the form of an O-ring made from an elastomeric material, for example a silicone rubber material.

The apparatus (11) is configured such that the seal (17) is situated within a seal groove (19). On the out-board side of the seal groove (19), that is the side that is exposed to atmospheric pressure, a gap (21) is provided between the lid (15) and the vessel (13). The size of the gap (21) is carefully calculated so that at least a part of the seal (17) is able to exit the sealing groove (19) and to relieve pressure from within the brewing vessel (13) if the pressure differential between the interior and the exterior of the brewing vessel (13) exceeds a predetermined pressure, for example a pressure of 2.5 to 3.0 bar.

In this example, the gap (21) between the brewing vessel (13) and the sealable lid (15) extends around the entire circumference of the O-ring (17). The silicon rubber seal (17) has a diameter or thickness of six millimetres and the seal (17) is normally squeezed by about 0.3 millimetres when the lid (15) is fitted onto the vessel (13). The gap (21) is approximately four millimetres wide. Testing has shown that the six millimetre diameter silicon rubber seal (17) will squeeze through the four millimetre gap (21) when the pressure in the vessel (13) reaches 2.5 to 3.0 bar. It is envisaged that the gap (21) should be between about 50% and 85% of the diameter or thickness of the rubber seal (17), and should preferably be in the range of about 60% to 75% of the diameter or thickness of the rubber seal (17).

The pressure at which gases are released from the vessel (13) by the pressure regulating valve (31) is lower than the predetermined pressure range which causes the seal (17) to exit the sealing groove (19) if required as a safety pressure release.

It can be seen that the apparatus (11) is configured such that it can be transported from one location to another. In this example, the apparatus (11) includes wheels (23) configured to allow apparatus (11) to be moved with ease from one location to another. Such transportation means are mainly intended for use with larger versions of the apparatus, as it is envisaged that smaller versions, being lightweight, could be transported manually from one location to another (for example, into one or more temperature controlled rooms or chambers at different stages of the brewing process as required).

In this example, the apparatus (11) also includes a pressurization system (25) configured to allow gas under pressure to be introduced into the vessel (13). While it is desirable to retain the natural carbon dioxide that is produced in the fermentation process to carbonate the beverage, it is also helpful to use supplementary carbon dioxide to maintain pressure over the beverage as the beverage is dispensed from the vessel (13) to prevent the beverage from becoming flat, and to help propel the beverage from the vessel (13).

The apparatus (11) can also include a dosing system (27) configured to allow materials such as clarifying agents to be introduced into the vessel (13) while the vessel (13) is pressurised. The dosing system (27) can be incorporated into the pressurization system (25) allowing the pressurized carbon dioxide source to be used to propel the dosed material into the already pressurised vessel (13).

The dosing system (27) can be an integral part of the apparatus (11), or it can include a separate dosing module that can be connected to the apparatus (11) when required for dosing functions. In this way, a single dosing module could be used to dose the contents of a number of vessels (13).

As with previous systems, the apparatus (11) also includes sedimentation removal means in the form of a valve (29) mounted at the lowest point of the vessel (13), to allow sedimentation products to be removed from the vessel (13) while the vessel remains pressurised.

The apparatus also includes a dispensing system (33). The dispensing system (33) allows liquid, for example beer or cider, to be dispensed directly from the pressurised vessel (13), ensuring that the user or customer is provided with the most fresh and contaminant free beverage possible.

The mobile or transportable version of the apparatus (11) is intended for use in situations where temperature controlled rooms or chambers are available. These vessels would therefore not require any on-board temperature control equipment as they could be moved to one or more temperature controlled rooms or chambers at different stages of the brewing process as required.

However, for stand alone versions of the apparatus (11), they can be equipped with a heating system (35) and/or a cooling system (37) configured to allow material inside the vessel to be heated to, or cooled to, or maintained at, a desired temperature irrespective of the ambient temperature surrounding the apparatus (11).

The brewing apparatus (11) can be used in a brewing facility, for example in a small brewing facility associated with a licensed public bar or a restaurant at which the brewing apparatus (11) can be used to make and to dispense fermented beverages to patrons.

If the brewing facility includes a temperature controlled room or chamber the brewing apparatus (11) can be of the type having no heating or cooling system as described above. In this case, the brewing apparatus (11) can be used in a method of brewing that includes the following steps of;
a) adding the appropriate brewing ingredients to the vessel, for example, when making beer, malt, malt extract, hops, yeast and water;
b) sealing the vessel;
c) selecting the desired pressure setting to allow carbonation of the contents of the vessel to occur naturally as a result of fermentation;
d) placing the brewing vessel into a first temperature controlled chamber or room while fermentation takes place;
e) allowing fermentation and natural carbonation to occur within the sealed vessel;
f) removing sediment from within the vessel while the vessel is under pressure;
g) giving the brewing vessel to a second temperature controlled chamber or room prior to and during consumption of the beverage contained within the vessel.

The method can optionally include movement of the vessel to a third temperature controlled chamber or room while maturation takes place.

Such a method removes the necessity for an on-board heating or cooling system or any temperature control equipment located on the vessel itself. The temperature controlled rooms or chambers can be controlled using conventional heating and or refrigeration systems. The absence of an on-board heating and/or cooling system, or any temperature control equipment, simplifies the brewing apparatus, making it less costly to produce, and also making cleaning and repair and maintenance of the system easier.

### SECOND EXAMPLE

With reference to FIGS. 3 to 5, a second example of a brewing apparatus (51) according to the present invention will now be described. The brewing apparatus (51) is similar in most respects with the first example of a brewing apparatus (11) described above, except as noted below.

The brewing apparatus (51) includes a removable undercarriage assembly (53) configured to enable the apparatus to be more easily transported from one location to another. In this example, the removable undercarriage assembly (53) includes a cylindrical body (55) which is supported on wheels (57). The body (55) can of course be of any desired shape and configuration (not necessarily cylindrical). The cylindrical body (55) includes access holes (59) configured to allow access to a sediment removal valve (61), and to allow a sediment removal container (63) to be connected to, or removed from, the sediment removal valve (61). The sediment removal container (63) is typically made from a material which is at least partly transparent, so that the level of sediment in the sediment removal container (63) can be seen.

The upper rim (65) of the cylindrical body (55) is configured to mate with a lower skirt (67) of a brewing vessel (69). The lower skirt (67) of the brewing vessel (69) includes a rebated step (71) which is configured to engage with the upper rim (65) of the cylindrical body (55).

An upper rim (73) of an upper collar (75) of the brewing vessel (69) is configured similarly to the upper rim (65) of the cylindrical body (55). In this way, the rebated step (71) of the lower skirt (67) of one brewing vessel (69) is able to engage with the upper rim (73) of the upper collar (75) of another brewing vessel (69). This allows one brewing vessel (69) (without the carriage assembly) to be stacked on top of another brewing vessel (69) (without the carriage assembly).

The upper collar (75) includes two hand holds (77) to assist with manual lifting and moving of the brewing apparatus (51). More than two hand holds can be present to assist with manual lifting and moving of the apparatus. For example, further hand holds could also be included on the lower skirt (67) of the apparatus.

The lower skirt (67) and/or the upper collar (75) can include access holes (78) which allow access to the dosing ports (79) and dispensing fittings (81) situated on an upper shoulder (83) of the lower brewing vessel (69), when one brewing vessel (69) is stacked on top of another brewing vessel (69) as shown in FIG. 5.

The brewing apparatus (51) includes a vibrator (84) or at least provisions to mount a vibrator. The use of a vibrator is helpful when removing sediment from the brewing vessel (69). In this second example of a brewing apparatus (51) a conical base portion (85) of the brewing vessel (69) has a shallower angle so that the overall height of the brewing vessel (69) can be kept to a minimum. As a consequence of the shallower angle, there is a reluctance of sediment to migrate to the sediment removal valve (61).

In this example, the conical base portion (85) has an angle of about thirty degrees to the horizontal, and it is envisaged that a conical base with an angle in the range of about twenty to fifty degrees to the horizontal will provide a suitable balance between the requirements to keep the overall height of the brewing vessel (69) to a minimum, while still allowing sediment removal.

Vibrations from the vibrator (84) can help to overcome the problem of sediment removal when the cone angle is quite shallow, by assisting the sediment in migrating downwards toward the sediment removal valve (61). In this example, the vibrator (84) is attached to the trolley or undercarriage assembly (53). In this way, a single undercarriage assembly (53) can be used to assist with the sediment removal from a number of brewing vessels (69) without the need for multiple vibrators (84). Alternatively, each brewing vessel (69) could include a vibrator or provisions to mount a vibrator.

In these figures it can be seen that the second example of a brewing apparatus (51) also includes a sealable lid (87) and a variable pressure regulating valve (89) similar to the first example (11). The second example of a brewing apparatus (51) also includes a pressure gauge (91) which indicates the pressure within the brewing vessel (69). The pressure gauge can be integral with the brewing apparatus as shown in this example, or the brewing apparatus could be configured to receive a removable pressure gauge. For example, the pressurization system or carbon dioxide inlet of the brewing apparatus could include means for receiving a pressure gauge which is able to indicate the pressure within the brewing vessel. In this way, a single pressure gauge could be used to test the pressure of a number of brewing vessels.

### THIRD EXAMPLE

With reference to FIGS. 6 to 12, a third example of a brewing apparatus (101) according to the present invention will now be described. The brewing apparatus (101) is similar to the first and second examples of a brewing apparatus described above, except as noted below.

The brewing apparatus (101) has all of the necessary components and connections located on the sealable lid of the apparatus (115). As shown in FIGS. 7 and 9, the sealable lid (115) includes a pressure gauge (116), a variable pressure relief valve (117), a first coupling means (118) for introducing a compressed gas, such as carbon dioxide or nitrogen, into the vessel, and a second coupling means (119) for receiving a dispensing system to allow the contents of the vessel to be dispensed while the vessel is pressurised. It is envisaged that the first or second coupling means could also be configured to receive a dosing system to allow materials such as clarifying agents to be introduced into the vessel while the vessel is pressurised. The pressure gauge (116) could be integral with the sealable lid or hatch as shown in FIGS. 7 and 9, or alternatively the lid (115) may be configured to receive a removable pressure gauge of some type. An extraction tube (120) is attached to the underside of the second coupling means (119) and extends downwards into the interior of the vessel for drawing off the contents of the vessel to the dispensing system. Preferably the extraction tube (120) has a filter fitting (121) at the bottom of the tube to prevent any rising hops and yeast particles being drawn off and blocking the tube and the dispense fittings.

The main advantage of locating these components in the lid of the vessel is that the vessel as well as all of the parts and fittings can be cleaned more easily and thoroughly. The lid can simply be removed from the vessel enabling easy access to the interior for cleaning and also for inspection to see if there is any visible build up of materials. It also enables the apparatus to be serviced or maintained and repaired much more easily.

The other major advantage of having all of the components located in the lid of the vessel is that manufacturing costs can be significantly reduced. Having all of the components located in the lid of the vessel means that there are less connection points or penetrations in the vessel itself. The brewing vessel (101) has only two openings, that is, the sealable lid opening and the bottom of the vessel comprising an opening for a valve for sediment removal. The fact that the lid includes all the necessary connection points eliminates the need for connection points in the main body of the pressure vessel. This means that the main pressure vessel portion of the brewing vessel (101) can have a relatively even skin thickness with no requirement for hard points in the side walls to facilitate connections. In this way, potentially harmful stress concentrations in the side walls when the brewing vessel (101) is pressurised, can be significantly reduced.

The vessel can therefore be manufactured more easily (with simplified manufacturing processes) and more cost effectively. It enables cheaper manufacturing processes, cheaper materials and/or thinner walled materials to be used, for example, blow moulding or rotational moulding of plastics materials, or thinner stainless steel.

A further advantage is that when the lid is removed, the extraction tube (120) is also removed which makes it easier to mix the ingredients at the start of the brewing process.

Preferably the sealable lid or hatch also includes one or more viewing windows (122) to provide a view of the interior of the vessel. These may be glass windows or transparent plastic windows (preferably shaded or tinted, or having removable covers, to prevent light strike of the contents). Preferably there is more than one viewing window (122) so that a torch can be shined through one window while looking through another window, to provide increased visibility.

The variable pressure relief valve (117) is preferably of the type configured to provide a vacuum safety relief (for example in the case where cooling water or air creates a vacuum which could distort the vessel), as well as a positive pressure release in the case of an over pressure situation. FIG. 10 shows such a variable pressure relief valve (117) in more detail by way of a cross-sectional view. The variable pressure relief valve (117) comprises a pressure portion (138) and a vacuum seal portion (139) at the bottom of the valve. The pressure portion (138) is configured such that it moves upwards when the vessel is subject to too much pressure. The vacuum seal portion (139) is configured such that it moves downwards when the vessel is subject to a vacuum, to allow inadvertent vacuums that may develop in the vessel to be relieved, for example if the vessel is hot washed, and is allowed to cool with the lid fitted. The variable pressure relief valve (117) also includes a means such as a knob (140) which can be manually operated to alter the amount of pressure required to release the pressure seal. The variable pressure relief valve (117) also includes a means such as a button (141) which can be manually operated to release pressure from the vessel by opening the vacuum seal.

Preferably the lid of the vessel also includes ergonomic features such as notches (136) at, near or around the circumference or edges of the lid to facilitate the removable and replacement of the lid and thus the opening and closing of the vessel.

As shown in FIG. 10, the lid of the vessel also includes the same backup safety pressure release system as described in the first example of the invention.

In this example, the brewing apparatus (101) includes a removable trolley or dolly assembly (103) to more easily transport the apparatus from one location to another. The trolley or dolly assembly (103) includes a cylindrical or other shaped body which is supported on wheels (105). The cylindrical body in this example is comprised of an upper receiving portion (107) which is configured to mate with or receive a lower portion (110) of a brewing vessel (101). For example, the lower skirt (110) of the brewing vessel (101) may include a rebated step (111) which is configured to engage with a corresponding groove or lip (112) on the upper receiving portion (107) of the trolley or dolly assembly (103). The upper receiving portion (107) of the trolley or dolly assembly is open to allow space for and access to the sediment removal system located at the bottom of the brewing vessel (101) as explained in more detail below. It is of course envisaged that the brewing apparatus (101) and/or the trolley or dolly assembly (103) could be adapted to allow for any other types of suitable mating configurations to be used between the two components.

The trolley or dolly assembly also comprises a lower base portion (108) which supports a plurality of spaced apart legs (109) spanning vertically between the upper receiving portion (107) and the lower base portion (108). The spaced positioning of the legs (109) provides access holes (109a) between the legs, allowing free access to the underneath of the brewing apparatus, for example for accessing the sediment removal valve (124), and to allow a sediment removal container (126) to be connected to, or removed from, the sediment removal valve (124). A wheel (105) is attached by a castor assembly (130) to the bottom of each leg, allowing for freer movement of the wheels and easier movement and transportation of the brewing vessel. In this example, the removable trolley or dolly assembly (103) has five legs and five wheels, however the assembly could be modified to have any number of legs and/or wheels provided it could adequately support and transport the brewing vessel.

Preferably the trolley or dolly assembly (103) is made of a suitably strong and durable plastics material. The trolley or dolly assembly is designed to move larger brewing vessels around, for example those larger than ten litres it is envisaged that smaller vessels, especially those made of a plastics material, would be sufficiently light and easy to move manually without assistance of a trolley or dolly).

In larger brewing vessels, additional hand holds can be included to assist with manual lifting and moving of the apparatus, as shown in FIG. 6 where there are two hand holds positioned at or near the top of the vessel and two hand holds (132) positioned at or near the bottom of the vessel.

In the third example of the brewing apparatus (101) the sediment removal container (126) includes a drain valve (128). This is to enable the accumulated sediment to be periodically drained as the sediment slowly accumulates in the removal container (126). This would therefore obviate the need to remove the sediment removal container (126) from the brewing vessel while the vessel is under pressure. In this case the sediment removal container (126) would be made from a material which is at least partly transparent, so that the level of sediment in the sediment removal container (126) could be seen. The configuration of the trolley or dolly assembly (103) is such that there is sufficient space between the drain valve (128) and the lower portion (108) of the trolley or dolly assembly to enable sufficient access to and use of the drain valve (128).

It is envisaged that the brewing apparatus of the invention could include a temperature gauge (134) which indicates the temperature within the brewing vessel. The temperature gauge can be integral with the brewing apparatus (in which case it would preferably be situated on the lid of the vessel), or the temperature gauge could be a removable indicator, for example, an adhesive temperature indicator. In this way, a single removable temperature gauge could be used to test the temperature of a number of brewing vessels.

As shown in FIG. 8, the brewing vessels of example three of the invention can also be stacked one on top of the other, without any trolley or dolly assembly and after removal of the sediment removal containers. This facilitates storage and transport of the vessels.

FIG. 11 shows the use of a supplemental CO2 bottle (143) to assist in the introduction of a clarification agent into the brewing apparatus (101) while it is pressurized. Pressurized CO2 is supplied via a supply line (144) to the top of a dosing pot (145). The clarification agent can be placed into the dosing pot (145) for subsequent transfer into the brewing apparatus (101).

By either increasing the pressure in the CO2 supply line until it exceeds the pressure within the brewing apparatus (101), or by relieving pressure from within the brewing apparatus (101) via the pressure relief valve (117) while the CO2 supply line is pressurized, the contents of the dosing pot (145) can be transferred into the brewing apparatus (101) using the pressure provided by the supplemental CO2 bottle (143).

A one way valve (146) can be used between the dosing pot (145) and the brewing apparatus (101) to prevent inadvertent flow of beverage from within the brewing apparatus (101) into the dosing pot (145).

FIG. 12 shows a typical beverage dispensing configuration. The supplemental CO2 bottle (143) and supply line (144) are used to maintain a desired pressure within the brewing apparatus (101) while the beverage is dispensed. In this way, the beverage continues to be dispensed under pressure and is prevented from becoming flat.

As noted previously, the CO2 supply line can be connected to the first coupling means or fitting (118), and a dispensing line (148) can be connected to the second coupling means or fitting (119). The beverage can be dispensed via a dispensing tap (149).

### VARIATIONS

Aspects of the present invention have been described by way of example only and it should be appreciated that modifications and additions may be made thereto without departing from the scope thereof.

In the examples described above, the first example of a brewing apparatus (11) includes a lid (15), but in an alternative configuration the apparatus (11) could include an openable door or hatch.

In the first example described above, the gap (21) between the brewing vessel (13) and the sealable lid (15) extends around the entire circumference of the O-ring (17). However, in an alternative configuration, the gap (21) could be confined to one or more sections about the circumference of the O-ring (17).

In the first example described above, the apparatus (11) includes wheels (23) configured to allow apparatus (11) to be moved with ease from one location to another. However, in an alternative configuration the apparatus could include skids, forklift provisions, or lifting eyes to facilitate transportation of the apparatus (11) from one location to another.

The second example of a brewing apparatus (51) includes the use of a sediment removal container (63). It is envisaged that the sediment removal container (63) itself could include a drain valve, similar to that shown in the third example of the brewing apparatus. This would be very useful in that the accumulated sediment could be periodically drained as the sediment slowly accumulates in the removal container (63).

As a further option, the need for a sediment removal container could be reduced, or even eliminated, by constructing the conical base portion of the brewing vessel in such a manner that the level of sediment can be seen, for example the conical base portion could be made from a see-through or opaque material, or could include a clear or opaque sight glass or window. This option would allow sediment to be discharged directly from the brewing vessel, via a sediment removal valve, when a quantity of sediment is observed within the conical base portion.

### DEFINITIONS

Throughout this specification the word “comprise” and variations of that word, such as “comprises” and “comprising”, are not intended to exclude other additives, components, integers or steps.

### ADVANTAGES

Thus it can be seen that at least the preferred form of the invention provides a brewing apparatus that can be mass manufactured in a much more cost effective manner, which means that the apparatus can be sold to the consumer (be it a home brewer or the owner of a commercial establishment) at a much lower cost, while still providing a means of producing fermented beverages of very high quality and with high repeatability. In embodiments which include most of the components in the lid of the vessel, different sized versions of the brewing apparatus can be manufactured more easily by mass production methods.

The cost savings are significant for a commercial establishment wishing to brew its own beverages on site, as such an establishment no longer needs to purchase a “brew pub” system which is very expensive and requires a commissioning period as well as a lot of contact and instruction from the supplier and a specialised brewer to operate. Instead, a series of the brewing apparatus of the invention (for example, between 1 to 20) can be purchased for significantly less cost and be used immediately as an “instant brewery”.

This not only provides cost savings, but also a much easier option for an establishment to be able to brew commercially if desired. Furthermore, beverages can be produced using the brewing apparatus of the invention at a much lower cost compared to purchasing beverages wholesale (or retail in the case of the home brewer). In addition, producing beverages on site significantly reduces the carbon footprint associated with the brewing process and the transportation of beverages.

The brewing apparatus of the invention are also much easier to clean thoroughly and to maintain and repair.

The brewing apparatus of the invention is also expected to have a long service life due to the design that minimises stress concentrations in the main pressure vessel of the brewing apparatus.

In addition, the apparatus has an inherent safety feature which is designed to almost fully eliminate any possibility of explosive failure from the high pressures that can be produced during a fermentation process.

Furthermore, the apparatus is able to be easily transported from one location to another making the brewing process much easier, especially if multiple brewing apparatus are used in a commercial establishment.

1. A brewing apparatus, the apparatus having;
a brewing vessel configured to contain material to be fermented and to hold the material at a pressure above atmospheric pressure as the material ferments,
the vessel having a sealable lid or hatch,
the sealable lid or hatch having at least the following components situated therein:
(1) a pressure regulating valve configured to relieve pressure from within the vessel if the pressure differential between the interior and the exterior of the brewing vessel exceeds a first predetermined pressure,
(2) a first coupling means configured to allow a compressed gas to be introduced into the vessel, and
(3) a second coupling means configured to receive a dispensing system to allow liquid within the vessel to be dispensed while the vessel is pressurised.

2. A brewing apparatus as claimed in claim 1, wherein the sealable lid or hatch has a third coupling means for receiving a dosing system to allow materials such as clarifying agents to be introduced into the vessel while the vessel is pressurised.

3. A brewing apparatus as claimed in claim 1, wherein the first or second coupling means is able to receive a dosing system to allow materials such as clarifying agents to be introduced into the vessel while the vessel is pressurised.

4. A brewing apparatus as claimed in claim 1, wherein the apparatus has a resilient seal configured to make a fluid tight seal between the vessel and the lid or hatch, the seal being adapted to relieve pressure from within the vessel if the pressure differential between the interior and the exterior of the vessel exceeds a second predetermined pressure.

5. A brewing apparatus as claimed in claim 4, wherein the seal is situated within a sealing groove, and wherein at least a part of the seal is able to exit the sealing groove to relieve pressure.

6. A brewing apparatus as claimed in claim 4, wherein the second predetermined pressure is in the range of about 2.5 to 3.0 bar.

7. A brewing apparatus as claimed in claim 4, wherein the pressure regulating valve is configured to relieve pressure from within the vessel before the pressure differential between the interior and the exterior of the brewing vessel exceeds the second predetermined pressure.

8. A brewing apparatus as claimed in claim 1, wherein the sealable lid or hatch also includes a pressure gauge or a means to receive a removable pressure gauge.

9. A brewing apparatus as claimed in claim 1, wherein the sealable lid or hatch also includes one or more viewing windows to provide a view of the interior of the vessel.

10. A brewing apparatus as claimed in claim 1, wherein the pressure regulating valve includes a vacuum safety relief means.

11. A brewing apparatus as claimed in claim 1, wherein the apparatus is configured for transportation from one location to another.

12. A brewing apparatus as claimed in claim 11, wherein the apparatus includes a removable carriage assembly with wheels.

13. A brewing apparatus as claimed in claim 1, wherein the apparatus further includes sedimentation removal means configured to allow sedimentation products to be removed from the vessel while the vessel is pressurised.

14. A brewing apparatus as claimed in claim 13, wherein the sedimentation removal means includes a sediment collection container having a drain valve to enable accumulated sediment to be periodically drained as the sediment accumulates while the vessel is under pressure without removal of the sediment collection container.

15. A brewing facility incorporating at least one brewing apparatus as claimed in claim 1.

16. A brewing facility as claimed in claim 15, further including at least one temperature controlled chamber or room.

17. A method of home or small scale brewing of a fermented alcoholic beverage, wherein said method occurs in a brewing apparatus as claimed in claim 1, and wherein said method includes the steps of;
a) adding the appropriate brewing ingredients to the vessel;
b) sealing the vessel;
c) selecting the desired pressure setting to allow carbonation of the contents of the vessel to occur naturally as a result of fermentation;
d) placing the brewing vessel into a first temperature controlled chamber or room while fermentation takes place;
e) allowing fermentation and natural carbonation to occur within the sealed vessel;
f) removing sediment from within the vessel while the vessel is under pressure;
g) moving the vessel to a second temperature controlled chamber or room prior to and during consumption of the beverage contained within the vessel.

18. A method as claimed in claim 17, wherein the method includes the further step of moving the vessel to a third temperature controlled chamber or room while maturation takes place.

19. A brewing apparatus as claimed in claim 2, wherein the apparatus has a resilient seal configured to make a fluid tight seal between the vessel and the lid or hatch, the seal being adapted to relieve pressure from within the vessel if the pressure differential between the interior and the exterior of the vessel exceeds a second predetermined pressure.

20. A brewing apparatus as claimed in claim 3, wherein the apparatus has a resilient seal configured to make a fluid tight seal between the vessel and the lid or hatch, the seal being adapted to relieve pressure from within the vessel if the pressure differential between the interior and the exterior of the vessel exceeds a second predetermined pressure.
